(19) United States
(12) Patent Application Publication
(10) Pub. No.: US 2005/0252513 A1
(43) Pub. Date: Nov. 17, 2005

(54) Gas supply system

(76) Inventor: John Dingley, Swansea (GB)

Correspondence Address: Ronald B Sherer, 103 South Shaffer Drive, New Freedom, PA, 17349, US

(21) Appl. No.: 10/515,100

(22) PCT Filed: May 23, 2003
(86) PCT No.: PCT/GB03/02237

§ 371 Date: Apr. 8, 2005

(30) Foreign Application Priority Data
May 23, 2002 (GB) 0211894.1

(51) Int. Cl. A62B 7/10

(52) U.S. Cl. 128/205.28

(57) ABSTRACT

A method and system for supplying gas to an external machine such as an anaesthetic machine in which gas is supplied to and exits from the machine (3) such that it forms part of a closed gas conduit loop (10) in which there is a variable volume reservoir (7) which adjusts and maintains pressure in the gas supply in the conduit (10) The variable volume reservoir (10) incorporates an excess pressure safety and an under pressure safety valve.

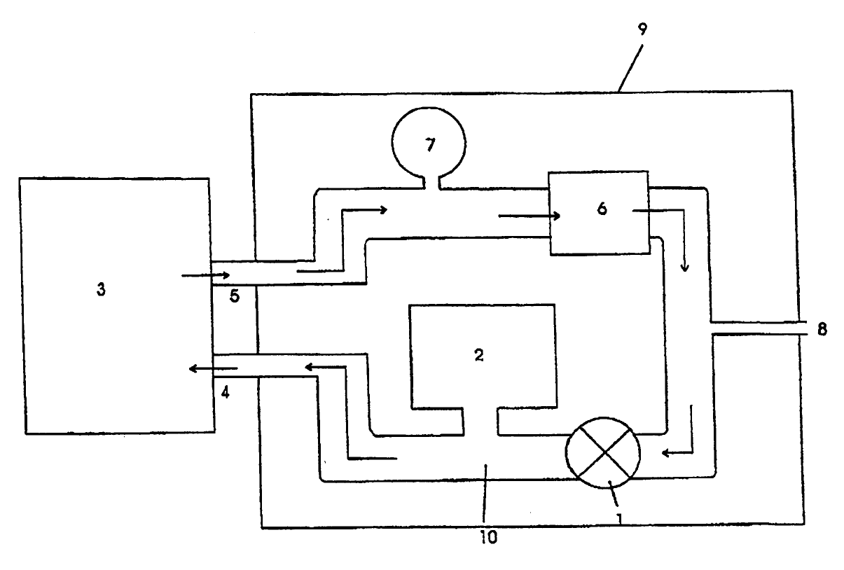

The present invention relates to a variable volume reservoir and to a method of using a variable volume reservoir to control gas flow.

The use of the variable reservoir of the present invention in the control of gases can have widespread applications and one particular application is in conjunction with medical procedures such as heart surgery and anaesthesia.

Many anaesthetic machines and mechanical ventilators used, for example, in operating theatres and intensive care units, consume large quantities of gas. This is not usually a problem as the gases used, such as oxygen, air, nitrous oxide, are low in cost. For example an oxygen/air (i.e. oxygen/nitrogen) gas mixture is commonly used by mechanical ventilators, and oxygen with nitrous oxide or air is commonly used by anaesthetic machines.

Alternative gases in combination with oxygen in the gas stream may be desirable in certain circumstances. Such alternatives may, for example, include more expensive gases, such as the gas xenon which is advantageous for its anaesthetic and/or brain protecting properties and which can cost around $10 per litre.

Many medical devices such as mechanical ventilators on intensive care, neonatal ventilators on special care baby units, and anaesthetic machines, are supplied with gas under pressure, usually from wall mounted pipelines or compressed gas cylinders. This pressure can vary but is typically 4 Bar, and gases are piped into the back of these machines at this sort of pressure.

In order to reduce costs when expensive gases are being employed, there needs to be a regulation or control of gases uses in order to prevent these gases being wasted. Patent application PCT/GB01/05288 describes a method and apparatus for effecting such control.

We have now devised a variable volume reservoir which can be used in conjunction with gas control systems to improve the operation of such gas control systems.

According to the invention there is provided a gas control apparatus which comprises (i) a variable volume gas reservoir having an inlet connectable to a gas circulation loop, (ii) an overpressure release means fluidically connected to the reservoir and (iii) a negative pressure safety means fluidically connected to the reservoir.

One embodiment of the variable volume reservoir can comprise a flexible bag or container such as a bag made of a rubber material which can expand and contract its volume in response to the gas pressure within the bag; another embodiment can comprise a bellows type structure or in a third embodiment the variable volume reservoir can comprise a tube or conduit open to the atmosphere which is of appropriate length e.g. 0.5 metres to 2 metres and the diameter of 1.5 to 3 cm e.g. about 2.2 cm.

The function of the overpressure release means is to allow excess gas to escape if the reservoir system is full, so as to prevent any inadvertent pressure build up in the system. Preferably the overpressure release means can comprise a spill valve of some sort and can act as an overpressure safety valve. Preferred pressures which will trigger the operation of the overpressure valve are pressures above 10 cm water and more preferably above 5 cm water, typically of 5 to 10 cm water.

The function of the negative pressure safety means is to allow ambient air to enter the system in the event of accidental gas loss from the system. This would prevent a negative pressure to build up in the system. The negative pressure safety means can operate if the pressure in the reservoir drops beneath 10 cm water below ambient and more preferably below 5 cm water, typically of below 5 to 10 cm water below ambient.

When the variable volume reservoir is an open ended tube i.e. a reservoir limb, the overpressure release means and negative pressure safety means can be automatically formed as, if gas is lost from the system, air is drawn into the system from atmosphere through the open end of the tube. If there is excess gas in the system for whatever reason, excess pressure cannot build up as the excess gas emerges from the open end of the tube.

The invention also provides a gas supply system comprising a gas conduit loop through which gas can flow in which loop there is (i) a pump which can pump gas around the gas conduit loop, (ii) a gas supply means to the loop, (iii) a supply conduit for the connection and supply of gas to an external machine, (iv) with gas pathways within the external machine being supplied from the loop, (v) a return conduit returning gas from the external machine for recirculation through the pump and (vi) a variable volume reservoir as described above. The external machine comprises part of the loop.

Preferably the pump generates a flow of gas around the loop and there is a pressure accumulator which stores gas under pressure and smoothes out undulations in the gas flow and pressure supplied to an external machine.

The external machine which can be, for example, a mechanical ventilator for neonates or adults or an anaesthetic machine and then the gas returning to the invention from the external machine may contain carbon dioxide. This is liberated from the body via the lungs. This carbon dioxide can be removed from the returning gas by passage through a carbon dioxide scrubber unit. This scrubber unit is typically filled with granules of soda-lime which absorbs carbon dioxide by a chemical reaction and is commonly used in anaesthesia machines. If the waste gas from the external machine does not contain carbon dioxide (for instance if the external machine has its own carbon dioxide scrubber), then the carbon dioxide scrubber unit need not be present.

In use, the pump propels gas around the loop and, as gas is removed from the loop by uptake in the patient from the gas circuits of the external machine being supplied, fresh gas is supplied via the gas supply means to replace this loss.

Preferably there is an oxygen supply means which, in the event of substantially complete emptying of the variable volume reservoir due to a fault with the gas delivery control system and the oxygen supply system causes oxygen not ambient air to enter into the loop. This oxygen supply means would perform the same function as the negative pressure safety means in preventing negative pressure build up in the loop, but it would do this by allowing ingress of oxygen rather than air. This would provide safety protection against both negative loop pressure and a low oxygen percentage in the gas in the loop if the gas delivery system to the loop developed a fault.

This could be achieved by, for example, providing a flow of oxygen on the outside of a negative pressure safety valve so that oxygen is drawn into the loop if the safety valve ever opened or making the negative pressure safety means a demand valve of a similar principle to those used in SCUBA diving so that, when a negative pressure is applied to the valve, it opens and allows oxygen to enter in a controlled manner from a high pressure oxygen source.

One or both of the overpressure release means and negative pressure safety means can be incorporated in the variable volume reservoir or they can be located at a position in the loop.

In use, that part of the loop region between the pump and the gas inlet to the external machine, plus the accumulator will be at the desired working pressure (e.g. 4 bar), while the rest of the loop will be at a much lower pressure. This lower pressure region will typically be at ambient pressure, because ambient pressure will be transmitted to the rest of the loop by the existence of the variable volume reservoir.

It is a feature of the invention that it enables one circular gas pathway, which includes the external machine being supplied with gas to be used and it provides a source of gas at the required working pressure of the external machine. Most of the loop is at or around atmospheric pressure. The variable volume reservoir allows for small short term volume changes in the loop without loss of gas from the loop.

The invention is illustrated in the accompanying drawing which shows a schematic drawing of an embodiment of the invention.

In the drawing the invention is used for supplying an oxygen containing gas e.g. to a mechanical ventilator and for removing carbon dioxide from the waste gas. The device is contained within a casing, (9) and consists of a gas supply system which comprises a gas conduit loop (10) in which there is a compressor (1) which compresses the gas to the working pressure (e.g. 4 Bar) and a pressure accumulator (2) which stores gas at the desired working pressure. The conduit (10) supplies gas to a machine (3) or other equipment to be supplied with gas through machine inlet (4) and waste gas or gas existing from the equipment (3) at the machine outlet is fed into the loop at (5). There is a carbon dioxide scrubber at (6) for removing carbon dioxide in the gas and a variable reservoir at (7). Further supplies of gas can be added at (8) to replace the gas used.

In use the pump (1) is started and the gas is fed into the loop (10) at gas entry (8) where it is compressed by the pump (1) and fed into the machine (3) at machine inlet (4). Waste gas returning from the external machine (3) is fed into the conduit at machine outlet (5) and pumped through a conduit in fluidic continuity with a variable volume reservoir (7) and passes through carbon dioxide scrubber (6). Further gas can be supplied through the gas inlet (8) to replace gas used up by the external machine.

If the loop gas volume rises, the variable volume reservoir automatically expands, so avoiding a pressure increase in the low pressure part of the loop that would otherwise occur and maintaining the pressure at a level substantially the same as before the volume increase occurred. If, due to an excessive loop volume increase for whatever reason, the variable volume reservoir fills to too high a level, an overpressure release valve in the reservoir (7) is automatically activated to vent gas from the loop so that the excess volume is released and the pressure maintained at acceptable levels. If the volume of gas in the loop drops the reservoir (7) contracts in volume maintaining the pressure; if the volume drops to too low a level an automatic negative pressure safety valve in the reservoir is activated to feed ambient air or a gas into the loop. This gas can be pure oxygen if desired. This process maintains the pressure in the loop substantially as before despite the fall in loop gas volume.

When the pump is running the region between the pump (1) and the gas inlet to the machine, plus the accumulator (2) will all be at the desired working pressure (e.g. 4 Bar), while the rest of the loop will all be at a much lower pressure. This lower pressure region will typically be at ambient pressure, because ambient pressure will be transmitted to the rest of the loop by the existence of the variable volume reservoir (7).

Preferably the pump speed will be continuously adjusted by a control system to just match the mean gas flow at the inlet (4) of the machine. This will then allow the accumulator (2) to always function at or about the desired working pressure (e.g. 4 Bar).

It is envisaged that fresh gases are put into the loop under the action of a gas control system. The gas entry point to the loop is shown at (8) but can be at any point within the loop. It is envisaged that, by appropriate instrumentation (such as a volume sensor attached to the variable volume reservoir), the variable volume reservoir (7) will always be maintained partially filled with gas, i.e. not completely empty and not completely full.

The only gas losses from the whole system will be that gas actually taken up from the external machine into the blood of the patient, for example via the lungs of the patient where the external machine is an anaesthetic machine.

If fresh gases are put into the gas loop at (8) at the same rate as they are being consumed by the patient i.e. the volume of gas in the variable volume reservoir (7) is kept constant by the control system, then this is the most efficient manner in which the machine can be operated in terms of economy of fresh gas use.

For example the total gas consumption (e.g. uptake from the lungs into the blood) of an anaesthetised patient might typically be 300 ml/minute. This is due to gases in the mixture being supplied to the lungs of the patient by the external machine being taken up into the blood from the lungs. Under normal circumstances most inhaled gas is not actually taken up into the blood via the lungs but is actually breathed out again. This explains why the example of 300 ml/min may intuitively seem rather low, compared to the volume of gas actually breathed in and out per minute, which can be of the order of 5 litres/minute.

The gas consumption of a mechanical ventilator (or other machine) being used in such a patient might be 5 litres/minute or greater. However the same machine supplied with gas by the invention might be expected to drop its total gas consumption to a rate approximately equal to the total gas uptake rate of the patient i.e. 300 ml/minute for example. Use of the invention thus produces a large saving on fresh gas consumption rate, useful if expensive gases are required.

Another mode of operation that is possible would be to supply fresh gases to the loop of the invention at (8) at a rate exceeding the gas uptake rate of the patient via, for example, the lungs. Excess gas would spill from the loop of the invention via a spill valve arrangement incorporated into the variable volume reservoir (7). This still would produce an economy of gas use so long as the total fresh gas flow at (8) is less than the fresh gas usage rate of the machine when used normally (i.e. not in conjunction with the invention). The economy would not be as great as with the mode of operation described above.

1. A gas control apparatus which comprises (i) a variable volume gas reservoir having an inlet connectable to a gas circulation loop, (ii) an overpressure release means fluidically connected to the reservoir and (iii) a negative pressure safety means fluidically connected to the reservoir.

2. A gas control apparatus as claimed in claim 1 in which the variable volume reservoir comprises a flexible bag or container, a bellows type structure or a tube or conduit open to the atmosphere.

3. A gas control apparatus as claimed in claim 1 or 2 in which one or both of the overpressure release means and negative pressure safety means are incorporated in the variable volume reservoir.

4. A gas supply system comprising a gas conduit loop through which gas can flow in which loop there is (i) a pump which can pump gas around the gas conduit loop, (ii) a gas supply means to the loop, (iii) a supply conduit for connection and supply of gas to an external machine, (iv) a return conduit returning gas from the external machine for recirculation through the pump and (v) a gas control apparatus as claimed in claim 1, 2 or 3.

5. A gas supply system as claimed in claim 4 in which there is a pressure accumulator which stores gas under pressure between the pump and the supply conduit.

6. A gas supply system as claimed in claim 4 or 5 in which the supply conduit and the return conduit are connected to an external machine and gas pathways within the external machine are supplied from the loop.

7. A gas supply as claimed in claim 6 in which the external machine is a mechanical ventilator or an anaesthetic machine.

8. A gas supply system as claimed in any one of claims 4 to 7 in which used gas from the external machine is fed back into the loop and then passes to the variable volume reservoir.

9. A gas supply system as claimed in any one of claims 4 to 8 for supplying and controlling the gas supply to a machine which system comprises a continuous gas conduit loop in which there is sequentially (i) a pump or compressor which pumps the gas around the loop, (ii) a gas accumulator, (iii) a supply conduit for connection and supply of gas to the machine, (iv) a return conduit returning gas from the machine for recirculation through the pump, (v) a variable volume gas reservoir in fluidic connection with the return conduit and (vi) a loop gas inlet for supplying gas to the loop whereby, in use, gas is pumped by the pump around the conduit through the machine via a gas inlet into the machine and a gas outlet out of the machine back into the loop, where the machine comprises part of the loop.

10. A gas supply system as claimed in any one of claims 4 to 9 in which there is a carbon dioxide scrubber through which exit gases from the external machine pass.

11. A gas supply system as claimed in any one of claims 4 to 10 in which there is an oxygen supply means which, in the event of substantially complete emptying of the variable volume reservoir, causes oxygen to enter into the loop.

12. A method for supplying and controlling a gas supply to a machine in which the gas is fed from a gas conduit loop under pressure into the machine through a machine gas inlet and out of the machine through a machine gas outlet back into the loop in which the machine forms a functional part of the loop, and in which the gas is pumped around the gas conduit loop and in which loop there is sequentially a pump, a pressure accumulator, the machine gas inlet, the machine gas outlet and a variable volume reservoir and in which there is an overpressure release means and a negative pressure safety means fluidically connected to the reservoir.

13. A method as claimed in claim 12 in which the variable volume reservoir comprises a flexible bag or container, a bellows type structure or a tube or conduit open to the atmosphere.

14. A method as claimed in claim 12 or 13 in which the machine is a mechanical ventilator or an anaesthetic machine.

15. A method as claimed in any one of claims 12 to 14 in which exit gases from the machine pass through a carbon dioxide scrubber.

16. A method as claimed in any one of claims 12 to 15 in which there is an oxygen supply means which, in the event of substantially complete emptying of the variable volume reservoir causes oxygen to enter into the loop.

17. A method as claimed in any one of claims 12 to 16 in which one or both of the overpressure release means and negative pressure safety means are incorporated in the variable volume reservoir.
